(19) United States
(12) Patent Application Publication
(10) Pub. No.: US 2008/0120284 A1
(43) Pub. Date: May 22, 2008

(54) RIS BROWSER FOR DIRECT ACCESS TO A RADIOLOGY INFORMATION SYSTEM FROM A DIAGNOSTIC IMAGING MODALITY SCANNER CONSOLE

(75) Inventors: Mark Vincent Profio, Elm Grove, WI (US); Kimberly Rae Stavrinakis, Richmond, VT (US); Sang Lee, Stevensville, MI (US); Regan Park Fields, Berea, OH (US); Christopher James Proctor, Aurora, CO (US); Holly Ann McDaniel, Waukesha, WI (US); David Alan Littlejohn, Wales, WI (US); Tony Edward Palmer, Williston, VT (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/858,007

(22) Filed: Sep. 19, 2007

Related U.S. Application Data
(60) Provisional application No. 60/867,033, filed on Nov. 22, 2006.

(51) Int. Cl. G06F 17/30

(52) U.S. Cl. 707/4

(57) ABSTRACT

Certain embodiments of the present invention provide methods and systems for remote access to a healthcare information system from a diagnostic imaging modality scanner console. Certain embodiments provide a browser located at a diagnostic imaging system console and configured to access a healthcare information system from a diagnostic imaging system console. The browser includes a data connection between a healthcare information system and a diagnostic imaging system console. The browser also includes an interface enabling remote access to information at the healthcare information system from the diagnostic imaging system console. The interface is also configured to enable remote retrieve and modification of information at the healthcare information system. Information at the healthcare information system may include patient exam order information, for example. The healthcare information system may include a RIS or PACS, for example.

### RELATED APPLICATIONS

This application claims priority to provisional application Ser. No. 60/867,033, filed on Nov. 22, 2006, entitled “RIS Browser for Direct Access to a Radiology Information System from a Diagnostic Imaging Modality Scanner Console,” which is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to communication between a healthcare information system and an imaging system or modality. In particular, the present invention relates to a browser for direct access to a healthcare information system from a diagnostic imaging modality scanner console.

A combination of yearly double digit increases in imaging demand and a continuing shortage of technologists and radiologists is resulting in increasing patient imaging exam order error rates. Some estimates place the number of errors as high as 30-40%. Limited Diagnostic Imaging (DI) scanner technologist access to Radiology Information Systems (RIS) and other healthcare information systems allows patient order errors to be propagated throughout a fully or partially digitized healthcare system. Diagnostic Imaging service providers are increasingly compelled to devote one or more FTE's (full time employees) exclusively to quality control to chase down errors and make manual corrections throughout the Diagnostic Imaging service chain.

Additionally, healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during an imaging scan of a patient, medical personnel may access patient information, such as the patient exam order, that are stored in a medical information system. Alternatively, medical personnel may enter new information, such as history, diagnostic, or treatment information, into a medical information system during an imaging scan.

### BRIEF SUMMARY OF THE INVENTION

Certain embodiments of the present invention provide methods and systems for remote access to a healthcare information system from a diagnostic imaging modality scanner console.

Certain embodiments provide a browser located at a diagnostic imaging system console and configured to access a healthcare information system from a diagnostic imaging system console. The browser includes a data connection between a healthcare information system and a diagnostic imaging system console. The browser also includes an interface enabling remote access to information at the healthcare information system from the diagnostic imaging system console. The interface is also configured to enable remote retrieve and modification of information at the healthcare information system. Information at the healthcare information system may include patient exam order information, for example. The healthcare information system may include a RIS or PACS, for example.

Certain embodiments provide a method for accessing healthcare information system functionality via a browser interface at a diagnostic imaging system. The method includes providing a browser interface for a healthcare information system at a diagnostic imaging system console. The method also includes facilitating review of information from the healthcare information system via the browser interface. The method further includes modifying information at the healthcare information system based on user input via the browser interface.

Certain embodiments may be implemented in a computer readable medium having a set of instructions for execution by a computer, for example. The computer-readable medium and its instructions may be used to provide a browser interface routine configured to execute on a diagnostic imaging system console. The browser interface routine may be configured to access information at a healthcare information system from a diagnostic imaging system console. The computer-readable medium and its instructions may also be used to provide a data connection routine facilitating exchange of data between the browser interface routine at the diagnostic imaging system console and the healthcare information system.

### BRIEF DESCRIPTION OF SEVERAL VIEWS OF THE DRAWINGS

FIG. 1 illustrates a block diagram for a system for interactive communication between a healthcare information system and an imaging system in accordance with an embodiment of the present invention.

FIG. 2 illustrates a block diagram for a diagnostic imaging system having a scanner and a browser in accordance with an embodiment of the present invention.

FIG. 3 shows an exemplary interface for a RIS browser at a diagnostic imaging system console in accordance with an embodiment of the present invention.

FIG. 4 illustrates a flow diagram for a method for accessing RIS functionality via a browser interface at a diagnostic imaging system in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Providing access to a Radiology Information System (RIS) and/or other healthcare information system, such as a Picture Archiving and Communication System (PACS), etc., directly from a Diagnostic Imaging (DI) scanner allows scanner technologists to correct errors in a patient imaging exam order prior to the exam. This capability improves quality control and outcomes for DI service providers and patients while also lowering overall costs of services. While certain embodiments described below may apply to a plurality of healthcare information systems, a RIS and a RIS browser will be discussed for purposes of illustration only.

In certain embodiments, a RIS Browser or other Viewer provides technologists and/or other users with direct access to a Radiology Information System and/or other healthcare information system from a scanner console. Using the browser, a user may perform a plurality of functions.

For example, a user may correct a patient exam order error, such as an incorrect scanning protocol, etc. A user may check for patient blood test results. A user may check for patient allergies/reactions to medications. A user may check for a patient's native language. A user may modify/add order accession number(s). A user may check patient height and weight and, if warranted, modify a scanning protocol appropriately. A user may execute Multiple Perform Procedure Step (MPPS) commands such as start and end procedure, in progress, in transport, patient waiting location, status of report (dictated, waiting for read, in progress), etc.

A user may use the browser to automatically send report and key images to referring physician. Via the browser, a user may pull up and review previous exams, results, history and diagnosis, for example. A user may save dose report and keep a running history in the RIS. A user may change/add a current exam order.

A user may check a patient's previous exam history and review reports. For example, a patient has an x-ray done for foreign body to remove metal prior to a magnetic resonance (MR) exam. A technologist reviews the report to ensure that the patient has been cleared before the MR.

The browser may be used to access the RIS track patient exam status (e.g., exam started, in-progress, completed, dictated, etc.), for example. The browser may also be used to enter additional patient history into an exam order for a radiologist or technician, for example.

The RIS Browser provides time, efficiency, and quality control benefits to providers of Diagnostic Imaging services. Making a full suite of patient information that is embedded in the Radiology Information System available to technologists and radiologists on a Diagnostic Imaging scanner console helps allow early correction of patient order entry errors and provides an opportunity for more appropriate patient care based upon patient indications while the user and/or the patient is actually at the scanner. Further, vital and specific additional patient information is easily made available to the RIS, and therefore RIS users, early in the DI services cycle for each patient.

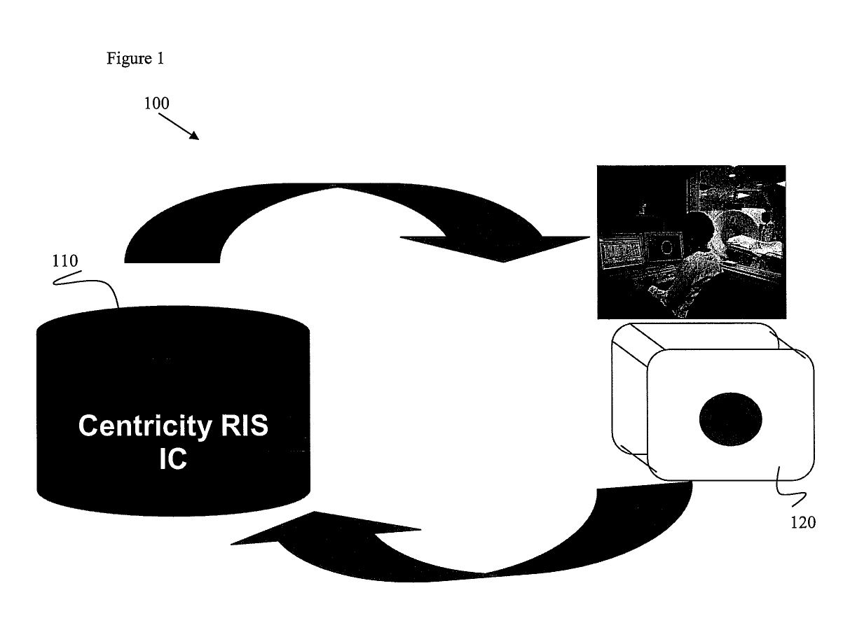

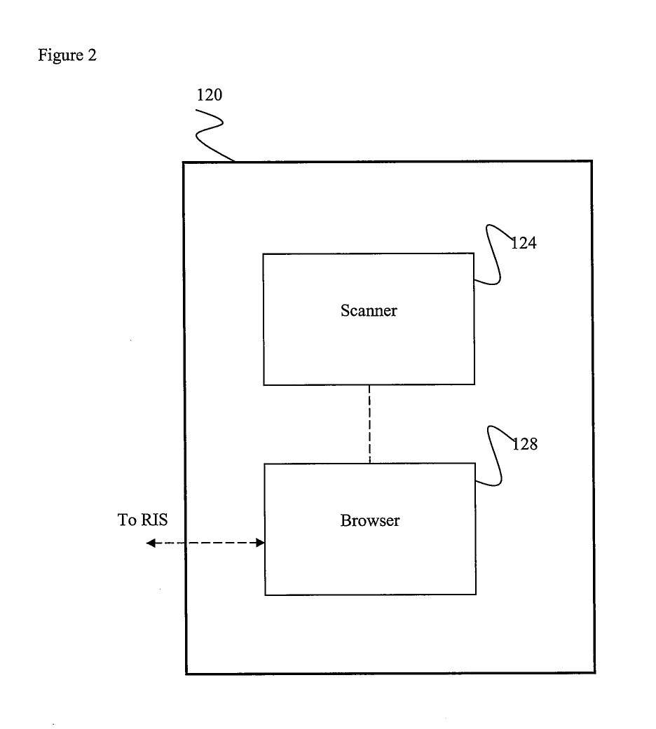

FIG. 1 illustrates a block diagram for a system 100 for interactive communication between a healthcare information system, such as a RIS, and an imaging system in accordance with an embodiment of the present invention. The system 100 includes a RIS 110 and a DI system 120 connected via one or more wired and/or wireless data communication connections. The RIS 110 includes patient information, order information, scanning protocol information, etc. As shown in FIG. 2, the DI system 120 includes an image acquisition scanner 124 and a browser 128, for example. The browser is configured to access the RIS 110 from the DI system 120. The components of the system 100 may be implemented in hardware, software and/or firmware alone and/or in various combinations, for example.

Using the browser 128, a user may view available information at the RIS 110, for example. In certain embodiments, the user may also modify information available at the RIS 110. In certain embodiments, a user may transmit commands and/or execute functionality at the RIS 110 via the browser 128 at the DI system 120. In certain embodiments, the browser 128 may enable access to other information system(s) and/or workstation(s) from the DI system 120.

From the DI system 120, the user may access a patient's imaging exam order. The user may review the exam order and/or other patient information and make changes to correct identified errors. Then, the exam may be correctly executed at the DI system scanner 120. The user may review other patient information to add in examining and/or conversing with the patient during the imaging exam. The user may also execute procedure commands and/or update patient/exam status remotely at the RIS 110 via the browser, for example. Using the browser, the user may also enter notes into a patient and/or exam report stored at the RIS 110 during a scan of the patient at the DI system 120.

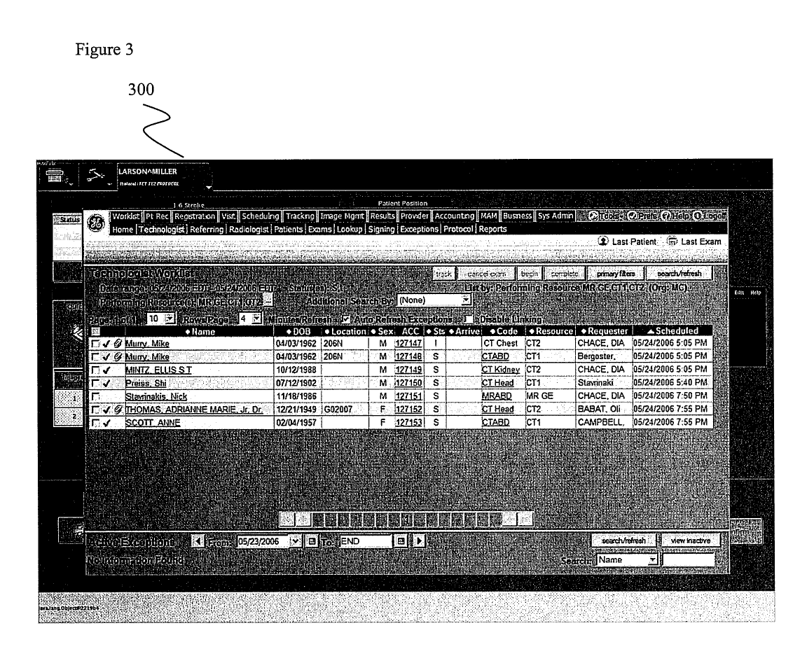

FIG. 3 shows an exemplary interface 300 for a RIS browser at a diagnostic imaging system console in accordance with an embodiment of the present invention. The exemplary interface 300 shown in FIG. 3 is displaying a technologist worklist to a user at a DI system. Note that the browser interface 300 may be used to access a variety of information/functionality at the RIS 110 and/or other information system, such as registration information, scheduling, patient records, visit information, tracking information, image management, results review, provider information, accounting, business information, system administration information, medical accounts management, other worklist information, etc. Worklists may include technologist, referring physician, radiologist, patient, exam, lookup, signing, exceptions, protocol, and report worklists, for example. Using the RIS browser interface 300, a user, such as a technologist, may view a list of patients to be imaged, modality, protocol/image scanning code, schedule, referring physician, location, etc. The user may modify information at the RIS via the interface 300, for example.

Via the RIS browser 128 at the DI imaging system 120, a user may access RIS 110 functionality including one or more subsystems and/or applications such as an order entry system, a results review system, a patient information system, a clinical decision support system, a configuration management system, a medication management system, a clinical information viewer, an allergy/problems database, a printing/reporting module, security, patient privacy protection, clinical scheduling, personal calendar, electronic mail, electronic messaging or “chat”, and/or medical resources, for example.

As illustrated, for example, in FIG. 3, via a worklist displayed through the browser interface 300, a user can view a patient listing including patient name and/or other identifier, patient location, patient status, action code, resource(s) used, requesting/referring physician, scheduled appointment, etc. A user may search based on patient name, identifier, resource, physician, code, location, etc. A user may filter the available information via the interface 300. The interface 300 may be personalized for a particular user, group of users, location, etc. In certain embodiments, information may be automatically refreshed at the interface 300 to provide the user with up-to-date information. In certain embodiments, a user may facilitate, among other things, registration, referral, ordering, billing, image and/or other results review and processing, scheduling, etc., for one or more patients, resources, and/or locations via the interface 300.

For example, the RIS browser may be used from a CT system to check Creatinine blood test results, check for allergies/reactions to medication, check for native language, correct patient order error, modify/add accession number, etc., at a RIS.

As another example, the RIS browser may be used from a CT or other IHE-enabled system to pull height and/or weight for a patient. If a patient as been scanned before, for example, retrieved height/weight may be used to set a patient size compensation curve for Auto-mA (CT automatic exposure control). The RIS browser may also be used to execute MPPS commands, such as Start & End Procedure, In progress, in Transport, Patient waiting location, Status of report (e.g., dictated, waiting for read, in progress, etc.), and the like.

Using the RIS browser, a user may automatically send report(s) and/or key image(s) to a referring physician, for example. A user may pull previous exams, results, history, and/or diagnosis information, for example. A user may save a dose report and keep a running history in the RIS, for example.

As another example, at an MR system, a user may change/add a current order via the RIS browser. A user may use the RIS browser to check a patient's previous exam history and review reports. For example, a patient previously had an x-ray done for a foreign body to rule out metal prior to an MR exam. A technologist may review the report to help ensure the patient has been cleared. As another example, the RIS browser may be used to track patient exam status (e.g., exam started, in-progress, completed, dictated, etc.). Via the RIS browser, a user can enter additional patient history into an exam order for a radiologist, for example.

As mentioned above, a RIS browser may be used to check Creatinine blood test results, as well as allergies and reactions to medication. A user may launch the RIS browser from a DI system, such as a CT scanner. The DI system may display a RIS technologist worklist as a default view, for example. In certain embodiments, user login may be synchronized, enabling the RIS user login screen to be bypassed.

The user selects a patient in the worklist and selects “ACC”, for example, to check Creatinine blood test results. The RIS browser then displays the lab result information on a clinical summary age, for example. The user may then cancel, for example, to return to the technologist worklist.

The user can then begin a scan via the DI system. For example, the CT system may activate a “ScanRx” screen to begin a scan of a patient. After completion of the scan, the user can close the session. At the close of the session, the RIS browser may toggle back to the technologist worklist awaiting a next action. After the user has completed the scan, the browser may display exam completion information, for example.

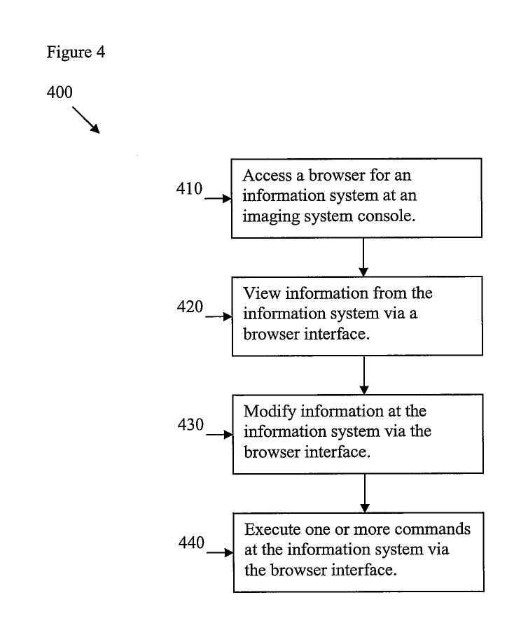

FIG. 4 illustrates a flow diagram for a method 400 for accessing RIS functionality via a browser interface at a diagnostic imaging system in accordance with an embodiment of the present invention. At step 410, at user accesses a RIS browser 128 at the DI system 120.

At step 420, information at the RIS 110 may be viewed via an interface triggered from the browser 128. Information may include patient information, scheduling, examination and/or other procedure codes, referrals, location, resources, orders, results, etc. For example, a user may check a patient's history and track exam status via the browser 128 and interface 300.

At step 430, information at the RIS 110 may be modified via the browser 128. For example, patient orders may be modified by a user via the interface 300 and browser 128. Additional patient history may be entered and stored at the RIS 110 via the interface 300 and browser 128, for example.

At step 440, procedure commands may be executed at the RIS 110 via the browser 128. For example, MPPS commands may be executed at the RIS 110 for a procedure with respect to a patient via the interface 300 and browser 128.

One or more of the steps of the flow diagram for the method 400 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Certain embodiments may be implemented in a computer readable medium having a set of instructions for execution by a computer, for example. The computer-readable medium and its instructions may be used to provide a browser interface routine configured to execute on a diagnostic imaging system console. The browser interface routine may be configured to access information at a healthcare information system from a diagnostic imaging system console. The computer-readable medium and its instructions may also be used to provide a data connection routine facilitating exchange of data between the browser interface routine at the diagnostic imaging system console and the healthcare information system. In certain embodiments, for example, the browser interface routine and data connection routine facilitate modification of information at the healthcare information system based on user input via the browser interface routine. In certain embodiments, for example, the browser interface routine and the data connection routine transmit a command for execution at the healthcare system based on user input via the browser interface routine. In certain embodiments, for example, the browser interface routine facilitates review and modification of a technologist worklist from the healthcare information system.

Thus, certain embodiments enable improved throughput and profitability using a RIS browser from a diagnostic imaging system console. Certain embodiments help to provide better patient care. Certain embodiments help provide increased user, patient and referring physician satisfaction. Certain embodiments help reduce denial of reimbursement expenses as well as costs of staff dedicated to managing patient order errors. Certain embodiments provide a technical effect of interaction and enhanced control between a RIS and a diagnostic imaging system.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or one or more dedicated processors.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A browser located at a diagnostic imaging system console and configured to access a healthcare information system from the diagnostic imaging system console, said browser comprising:
a data connection between a healthcare information system and a diagnostic imaging system console; and
an interface enabling remote access to information at the healthcare information system from the diagnostic imaging system console, the interface configured to enable remote retrieval and modification of information at the healthcare information system.

2. The browser of claim 1, wherein the interface enables review and modification of patient exam order information.

3. The browser of claim 1, wherein the interface enables execution of healthcare information system functionality.

4. The browser of claim 3, wherein the interface enables execution of procedure step commands at the healthcare information system.

5. The browser of claim 1, wherein the interface facilitates review and modification of a technologist worklist at the healthcare information system.

6. The browser of claim 1, wherein the healthcare information system comprises a radiology information system.

7. The browser of claim 1, wherein the healthcare information system comprises a picture archiving and communication system.

8. A method for accessing healthcare information system functionality via a browser interface at a diagnostic imaging system, said method comprising:
providing a browser interface for a healthcare information system at a diagnostic imaging system console;
facilitating review of information from the healthcare information system via the browser interface; and
modifying information at the healthcare information system based on user input via the browser interface.

9. The method of claim 8, further comprising executing at least one command at the healthcare information system based on user input via the browser interface.

10. The method of claim 9, wherein the at least one command includes at least one procedure step command.

11. The method of claim 8, wherein the information may include at least one of patient information, scheduling information, examination information, and patient order information.

12. The method of claim 8, further comprising authenticating access by a user to the healthcare information system via the browser interface at the diagnostic imaging system console.

13. The method of claim 8, wherein the information comprises a technologist worklist, and wherein the browser interface facilitates review and modification of a technologist worklist.

14. The method of claim 8, wherein the healthcare information system comprises a radiology information system.

15. The method of claim 8, wherein the healthcare information system comprises a picture archiving and communication system.

16. A computer readable medium having a set of instructions for execution on a computing device, said set of instructions comprising:
a browser interface routine configured to execute on a diagnostic imaging system console, said browser interface routine configured to access information at a healthcare information system from a diagnostic imaging system console;
a data connection routine facilitating exchange of data between the browser interface routine at the diagnostic imaging system console and the healthcare information system.

17. The computer readable medium of claim 16, wherein the healthcare information system comprises at least one of a radiology information system and a picture archiving and communication system.

18. The computer readable medium of claim 16, wherein the browser interface routine and data connection routine facilitate modification of information at the healthcare information system based on user input via the browser interface routine.

19. The computer readable medium of claim 16, wherein the browser interface routine and the data connection routine transmit a command for execution at the healthcare system based on user input via the browser interface routine.

20. The computer readable medium of claim 16, wherein the browser interface routine facilitates review and modification of a technologist worklist from the healthcare information system.
